(19) United States
(12) Patent Application Publication
(10) Pub. No.: US 2011/0216754 A1
(43) Pub. Date: Sep. 8, 2011

(54) TIME DELAY TRANSMIT DIVERSITY RADIOFREQUENCY DEVICE

(75) Inventors: Gregory Hey-Shipton, Santa Barbara, CA (US); Michael M. Eddy, Santa Barbara, CA (US)

(73) Assignee: ANTONE WIRELESS

(21) Appl. No.: 12/876,961

(22) Filed: Sep. 7, 2010

Related U.S. Application Data
(60) Provisional application No. 61/240,142, filed on Sep. 4, 2009.

(51) Int. Cl. H04B 7/06; H04W 88/08

(52) U.S. Cl. 370/342; 455/101

(57) ABSTRACT

A Time-Delay Transmit Diversity (TDTD) RF device is described for use to enhance the transmit performance of wireless communications systems. Time delayed signals are added to diversity antennas to increase coverage and capacity of wireless base stations. Performance is improved by reducing the effects of multipath fading while taking advantage of the additive effects of Rake receivers used in mobiles.

This application claims the benefit of U.S. Provisional Patent Application Ser. No. 61/240,142 to Eddy et al., filed on Sep. 4, 2010.

### BACKGROUND OF THE INVENTION

1. Field of the Invention

The field of the invention generally relates to the field of wireless communications. More specifically, the present invention relates to time-delay transmit diversity enhancement of the forward link of a wireless system, and in particular the field of the invention relates to the specific design features that are used to produce both a delayed signal on a diversity antenna, in addition to an amplified signal on the diversity antenna.

2. Description of Related Art

As mobile usage increases, wireless service providers are increasingly faced with the challenge of optimizing and/or expanding their wireless networks to provide better service for their customers while also minimizing their network capital expenditures. The dramatic increases in wireless data usage is further exacerbating the challenge of increasing capacity and coverage of wireless networks.

Wireless communications systems generally employ a plurality of base stations (BSs) which communicate with mobile stations (MSs) within a cell. The BSs are dispersed across a geographic service area and include at least one antenna and a base station transceiver system (BTS) to provide wireless service within the cell. The BTSs are coupled to base station controllers (BSCs) which may serve a plurality of BTSs. The BSC may also be coupled to a mobile switching center (MSC), capable of interfacing to the Public Switched Telephone Network (PSTN) and other BSCs.

As a MS moves around, transmitted signals on associated wireless channels are influenced by time-varying phenomena. Well-known communications phenomena such as shadowing, fading, doppler shifting, and polarization mismatches may affect the communications link performance between a MS and a corresponding BS.

Digital wireless systems may implement diversity transmission techniques to alleviate the effects of fading on a communications link between MSs and BSs. With diversity transmission, multiple replicas of the transmitted information are received at the receiving end. Each of the multiple replicas has an independent level of fading. By employing various receiver detection schemes (e.g., rake receiver) and exploiting the independent levels of fading, it is possible to recover a significant amount of any lost bit error-rate (BER) performance and improve overall system performance.

There are several diversity techniques that may be utilized in wireless systems. Such techniques include delay diversity, space diversity and polarization diversity schemes. Delay diversity relies on the property of minimum correlation between replicas of a direct-sequence (DS) spread-spectrum signal, delayed with respect to each other by more than the chip duration. A rake receiver recovers the delayed replicas of the signal to enhance the effective SNR into the detector.

CDMA systems are interference-limited. The number of users that can use the same spectrum and still have acceptable performance is determined by the total interference power of all users. Thus, the number of users that may be supported by each BTS is limited. In an effort to increase the capacity of CDMA systems, additional BSs may be added to increase the number of cells within the service area. However, because user traffic loads are often concentrated within small geographic areas, even with the addition of BSs, there may still be some cells that remain overloaded while neighboring cells are under-loaded. To alleviate such overcrowding in CDMA systems, multiple carriers may be assigned within a single service area to service the overlaying cells. With overlaying frequency coverage, some MSs are serviced by using one of the carrier frequencies while other MSs are serviced by relying on other carrier frequencies.

Generally, for such multicarrier operations, the BTS generates two or more carriers, which are then simultaneously transmitted by the BS. BSs that support multicarrier operations typically use two passive antennas per sector. Of the two passive antennas, one has transmit and receive capabilities, while the other has only receive capabilities. In doing so, such a configuration allows receive diversity. Multicarrier BSs are limited in their ability to mitigate other factors that compromise communications link performance between MSs and BSs.

High power, Multi-Carrier Power Amplifier (MCPA) booster systems are currently used in wireless networks to combine multiple base stations, so as to maintain cell site coverage or to improve the range of a cellular base station by amplifying the transmit signal. Generally, an MCPA Booster is mounted on the ground, close to a base station. MCPA Boosters improve signal quality by boosting the downlink (Tx) signal from the base station. This allows mobile subscribers to place more calls, place longer calls, increase data throughput, as well as reduce the number of dropped calls. This also reduces the overall number of base stations required to cover a specific area, hence, minimizing overall capital and operating expenditures. Wireless towers/base stations can be very expensive. For example, it has been estimated that each tower/base station can cost between about $500,000 and $750,000. In addition, each base station requires ongoing site lease expenses, backhaul (such as T1 lease), maintenance, totaling ˜$50,000 per year. Because if of this, MCPA Boosters have the ability to significantly reduce overall capital and operating expenditures on wireless infrastructure because a lower number of towers/base stations may be used to provide the same amount of coverage for a particular area.

However, current designs for MCPA Boosters are used only to increase coverage either for a single BS or multiple BS. In the current MCPA Boosters the transmit signal from the BS is attenuated and then re-transmitted on the same antenna. Thus, most of the power from the BS is dissipated as heat.

Thus, there is a need for an RF device that provides a more efficient means to provide an amplified transmit signal both for increased coverage and increased capacity. In the case of increased capacity, by using a time delay greater than 1 chip length (approximately 814 ns for CDMA2000 1X), diversity transmission from multiple antenna elements, amplifying the replica signal on the diversity antenna to match, or be greater than, the amplitude of the main signal, and taking advantage of MS rake receivers, additional capacity can be achieved for the same available spectrum without the inefficiency of wasting the original downlink transmit power.

### SUMMARY OF THE INVENTION

There is a need for systems and methods that overcome the limitation of using MCPA Boosters for improved coverage and capacity. One embodiment of such a radiofrequency device according to the present invention adapted for coupling between a base station and antenna comprises an enclosure having inputs operatively coupled to a base station to receive a transmit signal, and outputs operatively coupled to antennas. A transmission path is disposed within the enclosure including an amplifier, whereby a replica of the transmit signal is produced and delayed relative to the transit signal, and transmitted onto a separate transmit path in addition to the transmit signal from the base station.

Further features and advantages will become apparent upon review of the following drawings and description of the preferred embodiments.

### BRIEF DESCRIPTION OF THE DRAWINGS

FIG. 1A is a schematic diagram of a base station and antenna configuration, where the transmit signals are on one antenna.

FIG. 1B is a schematic diagram of a base station and antenna configuration, where the transmit signals are on both antennas.

FIG. 2A is a schematic diagram of a base station and antenna configuration, including the time delay transmit diversity system, where the transmit signals are on one antenna and the delayed transmit signals are on the other antenna.

FIG. 2B is a schematic diagram showing of a base station and antenna configuration, including the time delay transmit diversity system, where the transmit signals are on both antennas and the delayed transmit signals are respectively on the other antenna.

FIG. 3 illustrates the time delay transmit diversity system according to one aspect of the invention.

FIG. 4 illustrates the time delay transmit diversity system according to another aspect of the invention.

### DETAILED DESCRIPTION OF THE INVENTION

The improvements in coverage and capacity of MCPA Boosters according to the present invention can be realized by a delay of the replica signal on the diversity antenna that is less than 1 chip length (for improved coverage), or, greater than 1 chip length (for improved capacity). Tower mounted amplifiers (TMA's) or ground mounted amplifiers (GMA's) may be used in conjunction with the current invention in order to optimize the uplink and downlink. The antennas can be separated spatially, cross polarized or any other combination of antenna elements that de-correlates the signals emitted from the antennas.

In one aspect of the invention, for increased coverage, a transmit diversity MCPA radiofrequency (RF) device includes an enclosure having at least two inputs and two outputs, the inputs being coupled to a base transceiver station (BTS), the outputs being coupled to antennas. Original transmit signals from the BTS are on one main path. A replica of the transmit signals is generated onto a coupled path, which is delayed by the components in the coupled path, by lengths of coaxial transmission lines, optic fiber or acoustic wave devices (SAW or BAW), the total delay being less than 1 chip length and can be short, but greater than zero. This replica signal is then amplified and duplexed onto the diversity antenna. The amplification is such that, together with the original transmit signal power on the first main path, the required increase in coverage is achieved. In general, the amplification will be so that the delayed transmit power is similar to the original main transmit power, but more likely with more amplification so that the delayed transmit power is greater than the original main transmit power, in order to increase the overall coverage of the BTS.

In another aspect of the invention, for increased capacity, a transmit diversity MCPA radiofrequency (RF) device includes an enclosure having at least two inputs and two outputs, the inputs being coupled to a base transceiver station (BTS), the outputs being coupled to antennas. Original transmit signals from the BTS are on one main path. A replica of the transmit signals is generated onto a coupled path which is delayed by the components in the coupled path, by lengths of coaxial transmission lines, optic fiber or acoustic wave devices (SAW or BAW), the total delay being greater than 1 chip length. This replica signal can then be amplified and duplexed onto the diversity antenna. The amplification is such that the delayed transmit output power on the diversity path is similar to, or greater than, the transmit power on the original main path. This configuration can allow for more MS on the same sector and carrier before the maximum transmit output power from the BTS is reached.

In yet another aspect of the invention, for increased coverage, a transmit diversity MCPA radiofrequency (RF) device includes an enclosure having at least two inputs and two outputs, the inputs being coupled to a base transceiver station (BTS), the outputs being coupled to antennas. Original transmit signals from the BTS are on both paths to the antennas. Replicas of each of the transmit signals are generated onto coupled paths, which are delayed by the components in the coupled paths by lengths of coaxial transmission lines, optic fiber or acoustic wave devices (SAW or BAW), the total delay being less than 1 chip length and can be short, but greater than zero. These delayed replica signals are then amplified by multiple MCPAs and duplexed onto the other antenna path respectively. The amplification is such that the required increase in coverage is achieved. In general, the amplification will be such that the delayed transmit power is similar to the original main transmit power, but more likely with more amplification so that the delayed transmit power is greater than the original main transmit power, in order to increase the overall coverage of the BTS.

In yet another aspect of the invention, for increased capacity, a transmit diversity MCPA radiofrequency (RF) device includes an enclosure having at least two inputs and two outputs, the inputs being coupled to a base transceiver station (BTS), the outputs being coupled to antennas. Original transmit signals from the BTS are on both paths to the antennas. Replicas of each of the transmit signals are generated onto coupled paths, which are delayed by the components in the coupled paths, by lengths of coaxial transmission lines, optic fiber or acoustic wave devices (SAW or BAW), the total delay being greater than 1 chip length. These delayed replica signals are then amplified by multiple MCPAs and duplexed onto the other antenna path respectively. The amplification is such that the required increase in coverage is achieved. The amplification is such that the delayed transmit output power on each of the delayed paths is similar to, or greater than, the transmit power on the original main paths. This configuration will allow more MS on the same sector and carrier before the maximum transmit output power from the BTS is reached.

The present invention is described herein with reference to certain embodiments, but it is understood that the invention can be embodied in many different forms and should not be construed as limited to the embodiments set forth herein. In particular, devices can be arranged in many different ways with many different components beyond those described herein. Although the different embodiments of devices discussed herein with reference to being used for improved coverage and capacity of MCPA Boosters, it is understood that the embodiments can be used for many different applications and in many different systems.

It is also understood that when an element, feature or device is referred using such terms as being “mounted”, “located on” or “duplexed onto” another element, it can be directly on the other element or intervening elements may also be present. It is understood that these terms are intended to encompass different arrangements of the device in addition to the arrangements depicted in the figures.

Embodiments of the invention are described herein with reference to schematics and/or block diagrams that are schematic illustrations of embodiments of the invention. As such, the actual features and components of the devices can vary as many of the components may have suitable substitutes. Thus, the features illustrated in the figures are schematic in nature and their shapes are not intended to illustrate the precise arrangement of the device and are not intended to limit the scope of the invention.

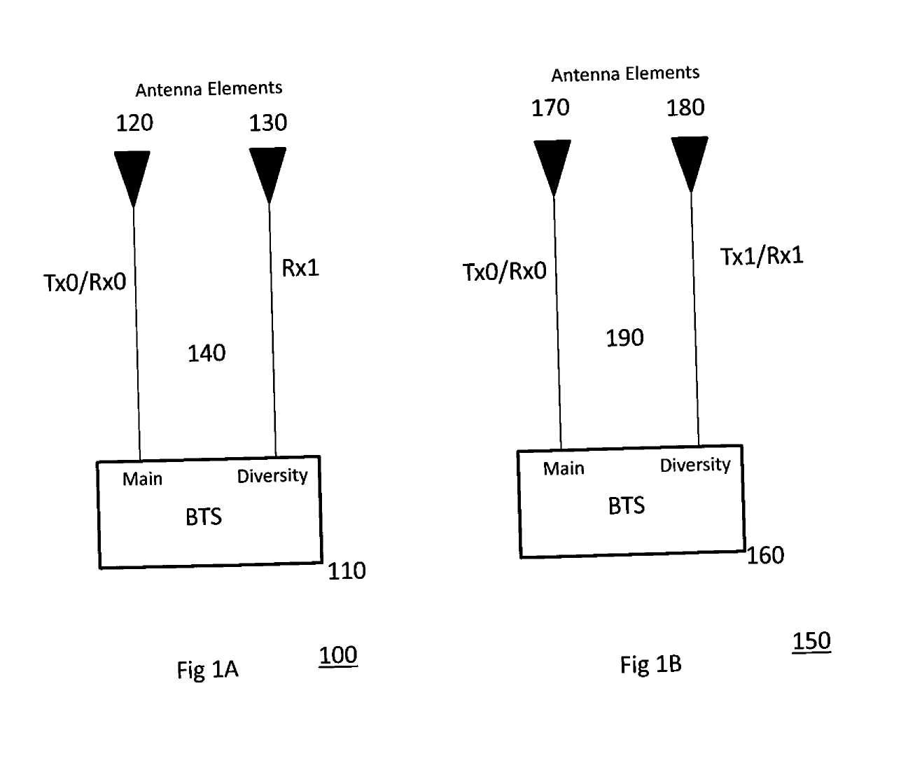

FIG. 1A is a schematic of a typical base station and antenna configuration 100. BS 100 is equipped with base station transceivers 110 which are coupled to passive antenna elements 120, 130 via coax cables 140. The antenna elements may be located in the same housing and arranged so as to provide receive diversity through polarization, or they may be separated spatially to achieve diversity. BS 100 may not possess transmit diversity so performance can be susceptible to fading effects.

FIG. 1B is a schematic of a typical base station and antenna configuration 150, where signals are transmitted from the BS onto both antenna elements. As more capacity is needed, and additional carriers are added to the BS, carriers are often transmitted on different antenna elements to minimize combining losses and to optimize power loads on the antenna elements. BS 150 is equipped with base station transceivers 160 which are coupled to passive antenna elements 170, 180 via coax cables 190. The antenna elements 170, 180 may be located in the same housing and arranged so as to provide receive diversity through polarization, or they may be separated spatially to achieve diversity. BS 150 may not possess transmit diversity so performance may be susceptible to fading effects.

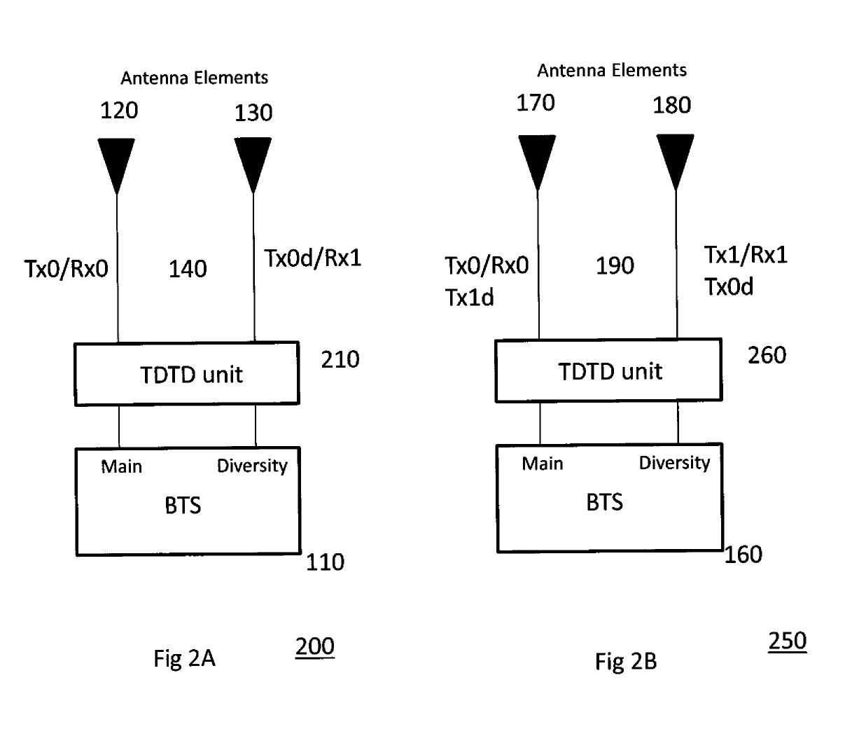

FIG. 2A is one embodiment of a base station and antenna configuration according to the present invention, with the time delay transmit diversity (TDTD) system 210 used in the case when transmit signals are only transmitted on one port from the BTS 110. The TDTD system 210 is located between the BTS 110 and antenna elements 120 and 130. The TDTD system 210 is usually located on the ground. However, the system could also be located in proximity to the antenna elements 120 and 130 to minimize coaxial cable losses. The TDTD system 210 generates a replica of the transmit signal, from the BTS 110 and adds this signal onto the diversity path to antenna element 130. Tower mounted amplifiers, or ground mounted amplifiers, can also be used so as to improve the performance of the receive path and optimize the link balance between transmit and receive.

FIG. 2B is one embodiment of a base station and antenna configuration according to the present invention with the time delay transmit diversity (TDTD) system 260 used in the case when transmit signals are transmitted on both ports from the BTS 160. The TDTD system 260 is located between the BTS 160 and antenna elements 170 and 180. The TDTD system 260 is usually located on the ground. However, the system could also be located in proximity to the antenna elements 170 and 180 to minimize coaxial cable losses. The TDTD system 260 generates replicas of the transmit signals, from the BTS 160 and adds these signals onto the other antenna path. Thus a replica of the transmit signal from the BTS which is transmitted on antenna element 170 can be generated in the TDTD system 260 and added to the path to antenna element 180. Similarly, the TDTD system 260 generates a replica of the transmit signal from the BTS which is transmitted on antenna element 180 and adds this to the path to antenna element 170. Tower mounted amplifiers, or ground mounted amplifiers can also be used so as to improve the performance of the receive path and optimize the link balance between transmit and receive.

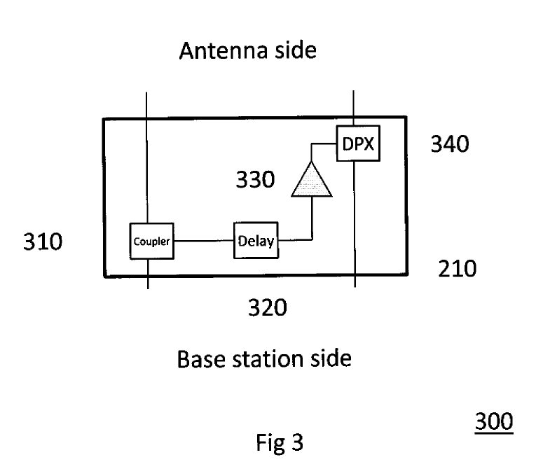

FIG. 3 is an embodiment of a TDTD system 300 according to the present invention. This system 300 can be used when transmit signals are only on one path from the BTS—designated the “main” path. This is usually when less capacity is needed. Within the TDTD system 210, a replica of the transmit signals is produced using a coupler 310. In one embodiment of this invention a 20 dB coupler can be used, so as to minimize the attenuation of the main transmit signals and provide the replica signal power at an appropriate input power level for the high power amplifier 330.

The replica signals can then be delayed using an appropriate delay mechanism 320. This could comprise some coaxial cable (for short delays) or optic fiber, which can require appropriate converters to convert the RF signals to light and then back from light to RF. For long delays, several 100 m of optic fiber can be used and in other embodiments surface acoustic wave (SAW) or bulk acoustic wave (BAW) devices with appropriate delays can be used. SAW or BAW devices are convenient as they can have large delays for a small size. There are only some of the delay mechanisms that can be used, and it is understood that any delay mechanism could be used that can delay the RF signal by the appropriate time.

After delay, the replica signals are amplified using a high power amplifier 330. The output power of the amplifier should be sufficient to provide increased coverage, in the case of a Booster application, or 120W-200W, but most likely in the 120 W-150 W range. Finally, the delayed, amplified replica signals can be added to the diversity antenna using a duplexer 340. The rejection requirements for the duplexer 340 can be sufficient to minimize any added noise on the receive signals from the added transmit.

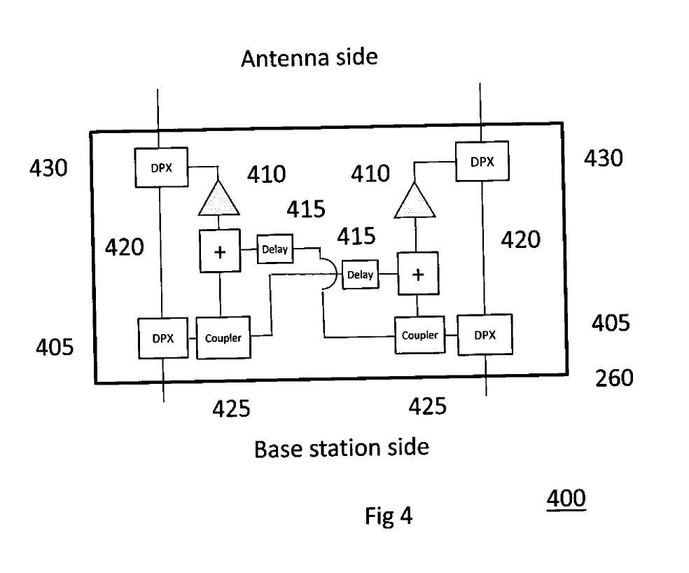

FIG. 4 illustrates a block diagram of another embodiment of the TDTD system 400 according to the present invention. This system 400 can be used when transmit signals are both paths from the BTS—designated the “main” and “diversity” path. This is usually when more capacity is needed, so additional spectrum is required. Within the TDTD system 260, the transmit signals can be separated from receive signals using duplexers 405. A replica of the transmit signals can be produced using a couplers 425. The replica signals are then delayed using an appropriate delay mechanism 415. This could comprise some coaxial cable (for short delays) or optic fiber, which can require appropriate converters to convert the RF signals to light and then back from light to RF.

For longer delays, several 100 meters of optic fiber may be used. Other longer delay embodiments can use surface acoustic wave (SAW) or bulk acoustic wave (BAW) devices with appropriate delays. SAW or BAW devices are convenient as they can have large delays for a smaller size. Any delay mechanism can be used that can delay the RF signal by the appropriate time. After delay, the replica signals are combined with the transmit signals on the other path from the BTS (which have not been delayed) using a combiner 420. The combined transmit signals are amplified using a high power amplifier 410. The output power of the amplifier must be sufficient to provide increased coverage, in the case of a Booster application, or 120W-200W, but most likely in the 120 W-150 W range.

Finally, the combined transmit signals can be duplexed onto the path to the antenna using a duplexer 430. The rejection requirements for the duplexers 405 and 430 must be sufficient to minimize any added noise on the receive signals from the added transmit. This same sequence of generating a replica signal, delaying with the appropriate time delay, combining with the transmit form the other BTS path, amplifying and then duplexing onto the antenna path is performed on the other path from the BTS also within the TDTD system. A variable attenuator will most likely be required in order to optimize the power levels of the transmit signals.

The TDTD systems according to the present invention can transmit signals and many different frequency bands and in some embodiments they can transmit signals within the range of 0.7 GHz to 3.5 GHz. The systems can also transmit signals pursuant to many different formats and standards, including but not limited to global standard for mobile communications (GSM), code division multiple access (CDMA), wideband code division multiple access (WCDMA), orthogonal frequency-division multiple access (OFDMA), single carrier frequency division multiple access (SCFDMA). The systems can also be arranged to provide gain to the signal received from and then transmitted, with some embodiments arranged arranged to provide a signal gain that is variable.

While embodiments of the present invention have been shown and described, various modifications may be made without departing from the scope of the present invention. The invention, therefore, should not be limited, except to the following claims, and their equivalents.

What is claimed is:

1. A radiofrequency device adapted for coupling between a base station and antenna comprising:
an enclosure having inputs operatively coupled to a base station to receive a transmit signal, and outputs operatively coupled to antennas; and
a transmission path disposed within the enclosure including an amplifier, whereby a replica of the transmit signal is produced and delayed relative to the transit signal, and transmitted onto a separate transmit path in addition to the transmit signal from the base station.

2. The radiofrequency device according to claim 1, further comprising a coupler to generate the replica transmit signal.

3. The radiofrequency device according to claim 1, wherein further comprising a coaxial transmission line to delay the replica transmit signal.

4. The radiofrequency device according to claim 1, comprising an acoustic wave device to delay the replica transmit signal.

5. The radiofrequency device according to claim 1, comprising a fiber optic device to delay the replica transmit signal.

6. The radiofrequency device according to claim 1, wherein the frequency band of the transmission and replica signal is within the range of 0.7 GHz to 3.5 GHz.

7. The radiofrequency filter device according to claim 1, wherein the transmit and replica transmit signals have a format from is either global standard for mobile communications (GSM), code division multiple access (CDMA), wideband code division multiple access (WCDMA), orthogonal frequency-division multiple access (OFDMA), single carrier frequency division multiple access (SCFDMA).

8. The radiofrequency filter device according to claim 1, providing a signal gain that is variable.

9. A radiofrequency device adapted for coupling between a base station and antennas comprising:
an enclosure having an input operatively coupled to a base station and outputs operatively coupled to antennas; and
a transmission path disposed within the enclosure including an amplifier, whereby said enclosure accepts a transmit signal and produces a replica transmit signal from the base station that is delayed relative to the transmit signal, and transmitted onto a second transmit path in addition to the transmit signal on a first transmit path, wherein the delay of the replica transmit signal is greater than the chip length of the signal being transmitted.

10. The radiofrequency device according to claim 9, comprising a coupler to generate the replica transmit signal.

11. The radiofrequency device according to claim 9, comprising a coaxial transmission line to delay the replica transmit signal.

12. The radiofrequency device according to claim 9, comprising an acoustic wave device to delay the replica transmit signal.

13. The radiofrequency device according to claim 9, comprising a fiber optic device to delay the replica transmit signal.

14. The radiofrequency device according to claim 9, wherein the frequency band of the transmission and replica signal is within the range of 0.7 GHz to 3.5 GHz.

15. The radiofrequency filter device according to claim 1, wherein the transmit and replica transmit signals have a format from is either global standard for mobile communications (GSM), code division multiple access (CDMA), wideband code division multiple access (WCDMA), orthogonal frequency-division multiple access (OFDMA), single carrier frequency division multiple access (SCFDMA).

16. The radiofrequency filter device according to claim 1, providing a signal gain that is variable.

17. A radiofrequency device adapted for coupling between base stations and antennas comprising:
an enclosure having input connections operatively coupled to one or more base stations to receive transmit signals, and outputs operatively coupled to antennas; and
transmission paths disposed within the enclosure including amplifiers, wherein replicas of the transmit signals from the base stations are produced, delayed relative to the transmit signals, and connected to a different transmit path in addition to an original transmit path from the base station.

18. The radiofrequency device according to claim 17, comprising two or more delay paths for delaying said replica transmit signal.

19. The radiofrequency device according to claim 17, wherein the delays of the replica transmit signals are less than 1 chip length.

20. The radiofrequency device according to claim 17, wherein delays of the replica transmit signals are by more than 1 chip length.

21. The radiofrequency device according to claim 17, comprising one or more couplers to generate the replica transmit signals.

22. The radiofrequency device according to claim 17, comprising one or more coaxial transmission lines to delay the replica transmit signals.

23. The radiofrequency device according to claim 17, comprising one or more acoustic wave devices to delay the replica transmit signals.

24. The radiofrequency device according to claim 17, comprising one or more fiber optic devices to delay the replica transmit signals.

25. The radiofrequency device according to claim 17, wherein the frequency band of the transmission and replica signal is within the range of 0.7 GHz to 3.5 GHz.

26. The radiofrequency filter device according to claim 17, wherein the transmit and replica transmit signals have a format from is either global standard for mobile communications (GSM), code division multiple access (CDMA), wideband code division multiple access (WCDMA), orthogonal frequency-division multiple access (OFDMA), single carrier frequency division multiple access (SCFDMA).

27. The radiofrequency filter device according to claim 1, arranged to provide a signal gain that is variable.
